(19) United States
(12) Patent Application Publication
(10) Pub. No.: US 2019/0134762 A1
(43) Pub. Date: May 9, 2019

(54) Method For Manufacturing An Aircraft Floor Rail Obtained By Crimped Assembly Of Two Parts, And Aircraft Floor Rail Thus Obtained

(71) Applicant: Airbus Operations S.A.S., Toulouse (FR)

(72) Inventors: Christophe Mialhe, Saint Sulpice (FR); Guy Mauran, Colomiers (FR)

(73) Assignee: Airbus Operations S.A.S., Toulouse (FR)

(21) Appl. No.: 16/161,634

(22) Filed: Oct. 16, 2018

(30) Foreign Application Priority Data
Nov. 8, 2017 (FR) 17 60466

(51) Int. Cl. B23P 11/00; B64D 11/06; B64C 1/20; B23P 25/00; B05D 5/08

(52) U.S. Cl. CPC B23P 11/005; B64D 11/0696; B64C 1/20; B05D 2202/25; B05D 5/08; B23P 2700/01; B05D 2507/01; B23P 25/00

(57) ABSTRACT

A method for manufacturing an aircraft floor rail includes a step of manufacturing, separately, a first part of the floor rail, comprising at least a first flange, from a corrosion-resistant first material, and a second part of the floor rail, comprising at least a second flange, from a second material having a density that is different from, in particular lower than, that of the first material, and a step of assembling the first and second parts of the floor rail by crimping.

### FIELD OF THE INVENTION

The present application relates to a method for manufacturing a rail obtained by crimped assembly of two parts, and to an aircraft floor rail thus obtained.

### BACKGROUND OF THE INVENTION

As illustrated in FIGS. 1 to 3, an aircraft 10 comprises a fuselage 12 in which there is positioned a floor 14 which, with the fuselage 12, delimits a passenger cabin 16 in which elements such as seats 18, units 20 or the like are positioned.

These elements 18, 20 are fixed to the floor 14 removably.

For that purpose, the floor 14 comprises cross beams 22 and rails 24 (or false rails) to which the elements 18, 20 positioned in the passenger cabin 16 are connected using fixing systems.

According to one configuration illustrated in FIGS. 4 and 5, an aircraft floor rail 24 has the shape of an I-section profile.

The rail 24 is made as a single piece and comprises a web 26, a first flange 28 at a first end of the web 26 and a second flange 30 at a second end of the web 26.

The first flange 28, which faces upwards when the rail 24 is mounted, comprises a slot 32 with a narrowed entry 34 allowing the elements 18, 20 positioned in the passenger cabin 16 to be attached.

The second flange 30 is fixed by the fixings 36 to the rest of the floor 14.

According to a first embodiment, the rails 24 are made from aluminum alloy. This first configuration has the advantage of reducing the on-board mass.

In service, the aluminum alloy rails 24 may corrode notably as a result of the pooling of liquid in the slot 32. During maintenance inspections, replacing corrosion-damaged floor rails 24 is a lengthy and costly task which increases the aircraft down-time and has an impact on maintenance costs.

According to a second configuration, the rails situated in regions referred to as wet are made from a corrosion-resistant material such as a titanium alloy.

However, corrosion-resistant materials are generally more expensive and have a higher density, which tends to increase the on-board mass.

### BRIEF SUMMARY OF THE INVENTION

Aspects of the present invention may overcome the disadvantages of the prior art.

One subject of the invention is a method for manufacturing an aircraft floor rail, the said floor rail comprising at least one web, a first flange having a fixing system and a second flange connected to the first flange by the web or webs, characterized in that the method comprises a step of manufacturing, separately, a first part of the floor rail, comprising at least the first flange, from a corrosion-resistant first material, and a second part of the floor rail, comprising at least the second flange, from a second material having a density that is different from, in particular lower than, that of the first material, and a step of assembling the first and second parts of the floor rail by crimping.

This solution makes it possible to optimize the floor rails by reinforcing them only where needed, thus making it possible to limit the increase in on-board mass.

According to another feature, an interface, configured to limit friction between the first and second parts and/or corrosion phenomena, is positioned between the first and second parts of the floor rail.

Another subject of the invention is a floor rail for aircraft, comprising at least one web, a first flange having a fixing system and a second flange connected to the first flange by the web or webs, characterized in that the floor rail comprises:
a first part, comprising at least the first flange, made from a corrosion-resistant first material,
a second part, comprising at least the second flange, made from a second material having a density that is different from, in particular lower than, that of the first material, and
at least one crimped joint connecting the first and second parts.

According to another feature, each crimped joint comprises at least one interface, positioned between the first and second parts, and configured to limit friction between the first and second parts and/or corrosion phenomena.

According to one embodiment, the interface comprises a coating applied to at least one contact surface of at least one of the first and second parts in contact with the other of the first and second parts.

According to another feature, the floor rail comprises a neutral-axis plane and the crimped joint is positioned at or very close to the plane of the neutral axis of the floor rail.

According to a first embodiment, each crimped joint comprises a bulge, secured to the second part or the first part, respectively, and a female form, secured to the first part or the second part, respectively, and configured to house the bulge and to immobilize it, after the female form has been deformed around the bulge.

The female form is a U-shaped slot which has two branches and a base, the branches being spaced apart, prior to deformation, by enough distance to house the bulge, the branches being long enough that their ends can be bent over and, after deformation, trap the bulge.

The U-shaped female form is connected to the first part.

According to a second embodiment, each crimped joint comprises a first bulge secured to the first part, a second bulge secured to the second part, and at least one complementary component configured to keep the first and second bulges pressed firmly against one another.

### BRIEF DESCRIPTION OF THE DRAWINGS

Further features and advantages will become apparent from the following description of the invention, which description is given solely by way of example with reference to the attached drawings among which:

FIG. 1 is a side view of an aircraft,

FIG. 2 is a cross section through an aircraft fuselage,

FIG. 3 is a diagram illustrating a unit positioned on a floor of an aircraft cabin,

FIG. 4 is a perspective view of an aircraft floor rail illustrating one embodiment of the prior art,

FIG. 5 is a cross section through the rail visible in FIG. 4,

FIG. 6 is a perspective view of an aircraft floor rail illustrating one embodiment of the invention,

FIG. 7 is a cross section through the rail visible in FIG. 6,

FIG. 8A is a perspective view of a first part of the rail visible in FIG. 6,

FIG. 8B is a cross section through the first rail part visible in FIG. 8A,

FIG. 9A is a perspective view of a second part of the rail visible in FIG. 6,

FIG. 9B is a cross section through the second rail part visible in FIG. 9A,

FIGS. 10A to 10C are cross sections through a first rail part illustrating various embodiments of the invention,

FIG. 11 is a cross section through an aircraft floor rail illustrating another embodiment of the invention,

FIG. 12 is a cross section illustrating in detail a joint region of the rail visible in FIG. 11,

FIG. 13 is a cross section through two aircraft elements assembled by crimping, illustrating another application of the invention, and

FIG. 14 is a cross section through two elements of an aircraft assembled by crimping, illustrating another application of the invention.

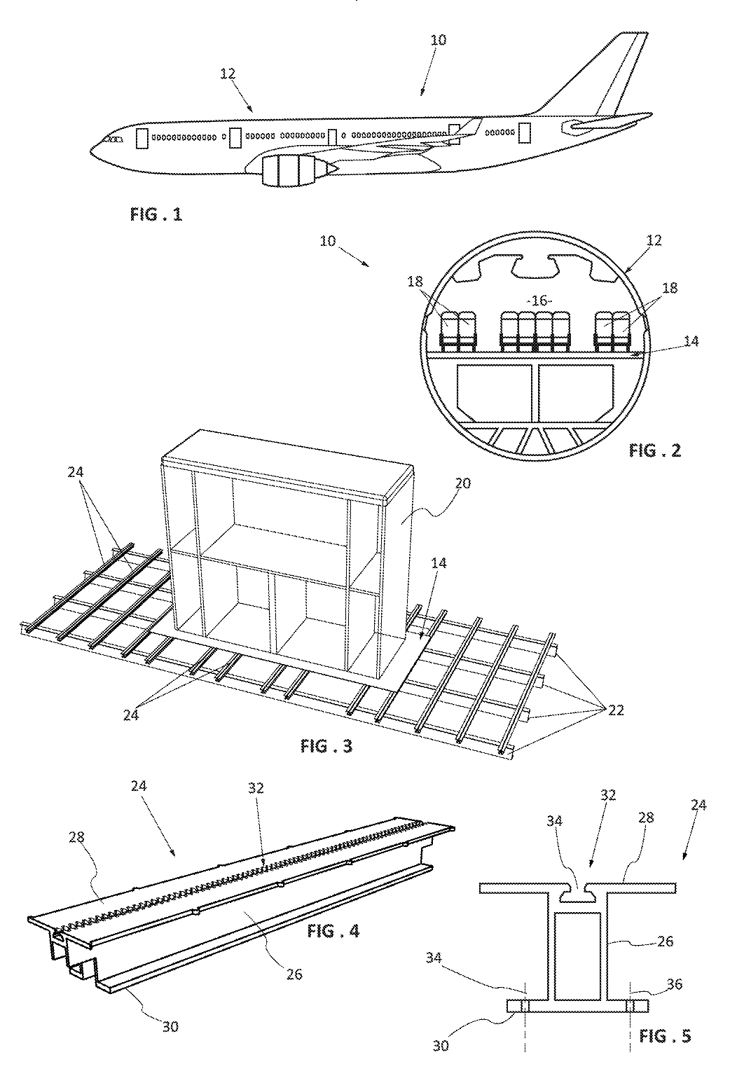

### DETAILED DESCRIPTION

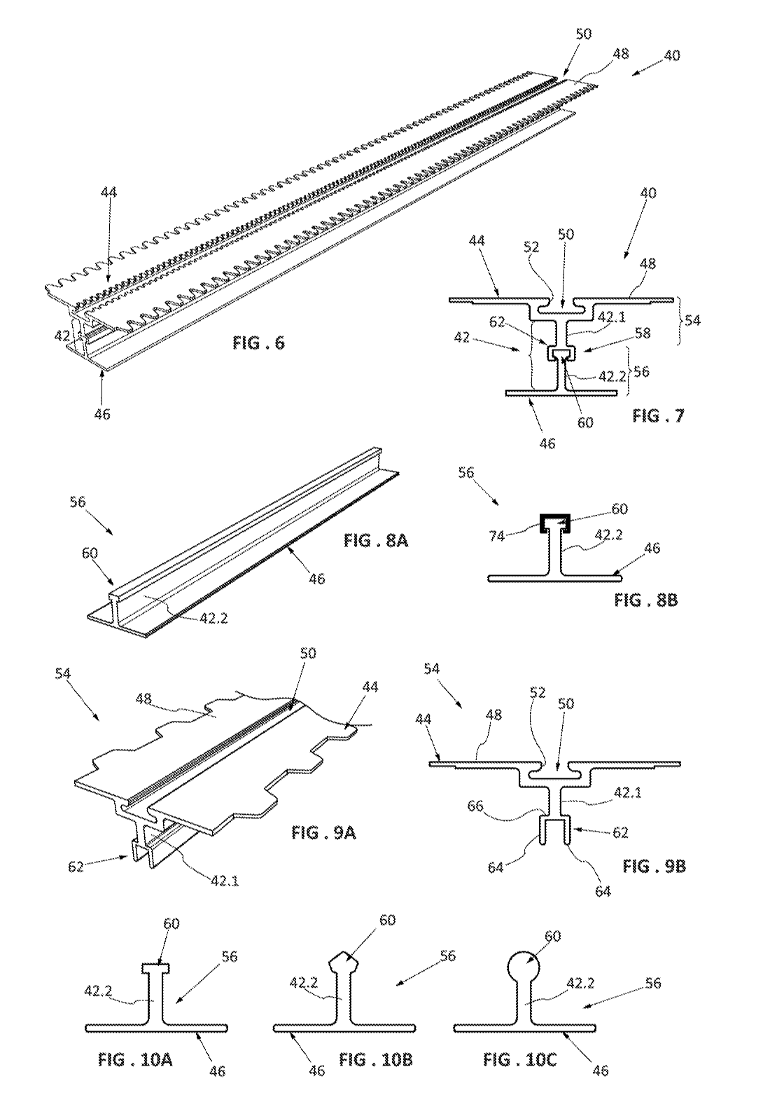

FIGS. 6, 7 and 11 depict an aircraft floor rail as 40.

For the purposes of the present application, a floor rail corresponds to a floor rail or to a false floor rail.

According to one embodiment, the floor rail 40 has an I-section and comprises at least one web 42, a first flange 44 at a first end of the web 42 and a second flange 46 at a second end of the web 42.

The first flange 44 comprises a first surface 48, the opposite surface to the web 42, and which faces upwards when the floor rail 40 is mounted, this first surface having a slot 50 with a narrowed entry 52.

The second flange 46 comprises orifices for fixing it to a bearing structure of an aircraft using fixings.

The shapes of the first flange 44, of the second flange 46 and of the slot 50, the fixings, the bearing structure are not described further because they may be identical to those of the prior art.

According to an embodiment of the invention, the floor rail 40 comprises a first part 54 which comprises at least the first flange 44, a second part 56 which comprises at least the second flange 46 and at least one crimped joint 58 connecting the first and second parts 54, 56.

According to one feature of the invention, the first part 54 is made from a first material and the second part 56 is made from a second material that is different from the first material, that has a density that is different from that of the first material. The first and second materials are chosen according to the stresses imposed on the first and second parts 54, 56.

Thus, in the case of a floor rail 40 situated in a wet zone, the first part 54 is made from a corrosion-resistant first material, such as titanium for example, and the second part 56 is made from a material of limited density, such as an aluminum alloy for example.

According to an aspect of the invention, the method for manufacturing an aircraft floor rail 40 comprises a step of manufacturing, separately, the first and second parts 54, 56 and a step of assembling the first and second part 54, 56 by crimping.

This aspect of the invention makes it possible to obtain an optimized dual-material floor rail 40, the first part 54 of the floor rail 40 which is subjected to risks of corrosion being made from a corrosion-resistant material, the second part 56 which is not subjected to risks of corrosion being made of a material that has a density lower than that of the material used for the first part 54.

According to another advantage procured by the crimped assembly, it is possible to manufacture the first and second parts 54, 56 using different manufacturing techniques which are best suited to the properties desired for each of the first and second parts 54, 56.

According to another advantage, the method of assembling using crimping is a rapid mechanical assembly technique that can easily be automated and requires no special quality control, unlike other assembly techniques such as welding.

According to one embodiment, the first part 54 comprises the first flange 44 and a first portion 42.1 of the web 42 and the second part 56 comprises the second flange 46 and a second portion 42.2 of the web 42. According to this embodiment, the first and second parts 54 and 56 have a T-shape.

According to embodiments visible in FIGS. 6, 7, 8A, 8B, 9A, 9B, 10A to 10C, the crimped joint 58 comprises a bulge 60, secured to the second part 56 (or, respectively, to the first part 54), and a female form 62, such as a slot, secured to the first part 54 (or, respectively, to the second part 56), configured to house the bulge 60 and to immobilize it after the female form 62 has been deformed around the bulge 60. Thus, after the crimping operation, the first and second parts 54, 56 are immobilized relative to one another.

The bulge 60 may have various cross sections.

According to one embodiment visible in FIGS. 8B and 10A, the male form 60 has a square or rectangular cross section.

According to one embodiment visible in FIG. 10B, the male form 60 has a lozenge-shaped cross section.

According to one embodiment visible in FIG. 10C, the male form 60 has a round, ovoid or oblong cross section.

Of course, the invention is not restricted to these cross sections.

According to one embodiment visible in FIG. 9B, the female form 62 has a U-shaped slot which has two branches 64 and a base 66 connected to the rest of the first part 54. The branches 64 are spaced apart, prior to deformation, by enough distance to house the bulge 60. The branches 64 are long enough that their ends can be bent over and, after deformation, trap the bulge 60.

This U-shaped female form 62 secured to the first part 54, which envelops the bulge 60 secured to the second part 56 contributes towards protecting the second part 56 from corrosion.

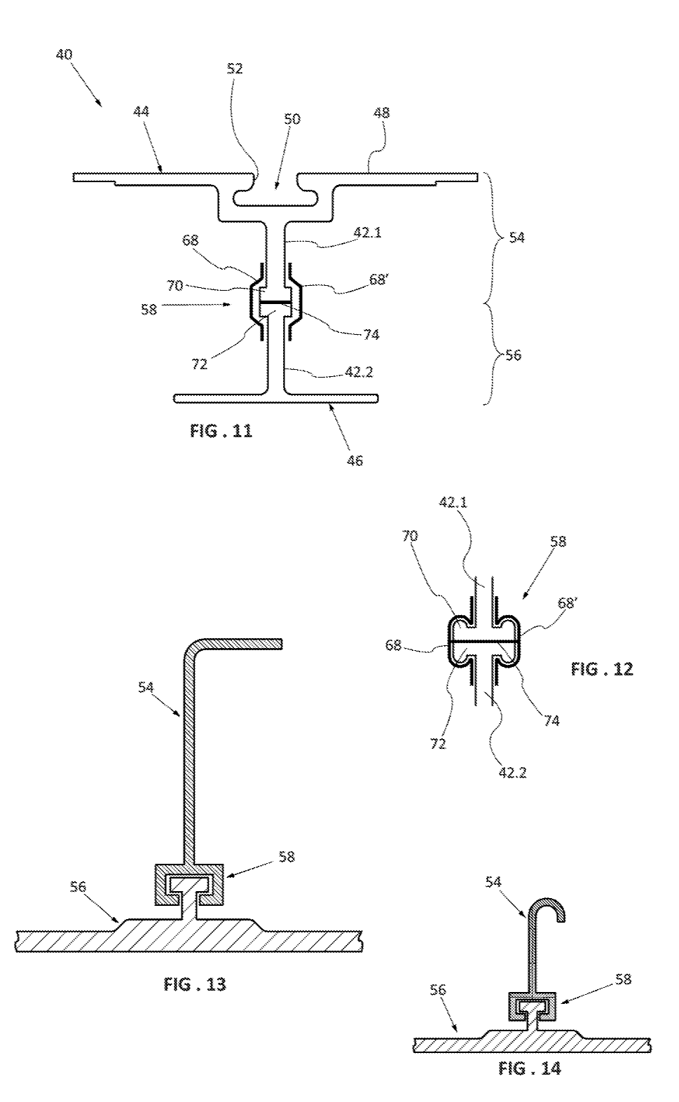

According to another embodiment visible in FIGS. 11 and 12, the crimped joint 58 comprises at least one complementary component 68, 68′ for connecting the first and second parts 54, 56.

According to this embodiment, the crimped joint 58 comprises a first bulge 70 secured to the first part 54, a second bulge 72 secured to the second part 56, and at least one complementary component 68, 68′ configured to keep the first and second bulges 70, 72 pressed firmly against one another.

According to another feature, the crimped joint 58 is positioned at or very close to the plane of the neutral axis of the floor rail 40 in order to minimize loading on the crimped joint 58.

According to another feature, the crimped joint 58 comprises at least one interface 74, positioned between the first and second parts 54 and 56, and configured to limit friction between the first and second parts 54 and 56 and/or galvanic corrosion phenomena.

According to one embodiment, the interface 74 comprises a coating on at least one of the first and second parts 54, 56. This coating is applied to at least the contact surface of at least one of the first and second parts in contact with the other part.

By way of example, the interface 74 is made of polyethylene.

Although described in an application to a single-web aircraft floor rail 40, the invention is not in any way restricted to that application. Thus, the invention may be applied:
to a multi-web floor rail 40, each web comprising a crimped joint 58,
to a floor rail 40 of omega-section or any other cross section,
to a floor rail 40 having, in place of the slot 50, another fixing system, such as, for example, a rib projecting from the first surface 48 of the first flange 44.

More generally, aspects of the invention can be used for assembling two elements of an aircraft, such as, for example, a profile section 54 and a support 56.

Thus, according to an application illustrated in FIG. 13, the profile section 54 is a frame of an aircraft fuselage structure, which frame is assembled by crimping, and the support 56 is a skin of the aircraft fuselage, the frame being assembled to the skin by a crimped joint 58.

According to another application illustrated in FIG. 14, the profile section 54 is a stringer of an aircraft fuselage structure and the support 56 is a skin of the aircraft fuselage.

Whatever the application, the profile section is a long linear element which has a length markedly greater than the other dimensions of its cross section which is approximately constant. The profile section may be substantially rectilinear in the case of a rail or of a stringer and may be curved in the case of a frame.

Whatever the application, the crimped joint between the profile section 54 and the support 56 is positioned at or very close to the plane of the neutral axis of the assembly formed by the profile section 54 and the support 56 so as to minimize loading on the crimped joint 58.

In addition, the profile section 54 and the support 56 are made from first and second materials which are different, chosen according to the stresses imposed on the profile section 54 and on the support 56. Thus, the first and second materials may have properties which, for example, favor good tensile strength in the case of the first material, good compression strength in the case of the second material, or good fatigue strength in the case of the first material and good static strength in the case of the second material, or any other combination of properties.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for manufacturing an aircraft floor rail, said floor rail comprising at least one web, a first flange having a fixing system and a second flange connected to the first flange by the web or webs, the method comprising:
a step of manufacturing, separately, a first part of the floor rail, comprising at least the first flange, from a corrosion-resistant first material, and a second part of the floor rail, comprising at least the second flange, from a second material having a density that is different from that of the first material; and
a step of assembling the first and second parts of the floor rail by crimping.

2. The method for manufacturing an aircraft floor rail according to claim 1, wherein an interface, configured to limit friction between the first and second parts and/or corrosion phenomena, is positioned between the first and second parts of the floor rail.

3. The method for manufacturing an aircraft floor rail according to claim 1, wherein the second material has a density lower than a density of the first material.

4. A floor rail for aircraft, comprising at least one web, a first flange having a fixing system and a second flange connected to the first flange by the web or webs, wherein the floor rail comprises:
a first part, comprising at least the first flange, made from a corrosion-resistant first material; and
a second part, comprising at least the second flange, made from a second material having a density that is different from that of the first material, and
at least one crimped joint connecting the first and second parts.

5. The floor rail according to claim 4, wherein the second material has a density lower than a density of the first material.

6. The floor rail according to claim 4, wherein each crimped joint comprises at least one interface, positioned between the first and second parts, and configured to limit friction between the first and second parts and/or corrosion phenomena.

7. The floor rail according to claim 6, wherein the interface comprises a coating applied to at least one contact surface of at least one of the first and second parts in contact with the other of the first and second parts.

8. The floor rail according to claim 4, wherein the floor rail comprises a neutral-axis plane, and
wherein the crimped joint is positioned at or very close to the plane of the neutral axis of the floor rail.

9. The floor rail according to claim 4, wherein each crimped joint comprises a bulge, secured to the second part or the first part, respectively, and a female form, secured to the first part or the second part, respectively, and configured to house the bulge and to immobilize the crimped joint, after the female form has been deformed around the bulge.

10. The floor rail according to claim 9, wherein the female form is a U-shaped slot having two branches and a base, the branches being spaced apart, prior to deformation, by enough distance to house the bulge, the branches being long enough that the ends of the branches can be bent over and, after deformation, trap the bulge.

11. The floor rail according to claim 10, wherein the U-shaped female form is connected to the first part.

12. The floor rail according to claim 4, wherein each crimped joint comprises a first bulge secured to the first part, a second bulge secured to the second part, and at least one complementary component configured to keep the first and second bulges pressed firmly against one another.
